(19) United States
(12) Patent Application Publication
(10) Pub. No.: US 2019/0304349 A1
(43) Pub. Date: Oct. 3, 2019

(54) Television Template Kit with Different Sized Sheets

(71) Applicant: Rusty Deeble, Long Beach, CA (US)

(72) Inventor: Rusty Deeble, Long Beach, CA (US)

(21) Appl. No.: 16/368,674

(22) Filed: Mar. 28, 2019

Related U.S. Application Data
(60) Provisional application No. 62/649,739, filed on Mar. 29, 2018.

(51) Int. Cl. G09F 15/02; G09F 15/00; B65D 59/04

(52) U.S. Cl. CPC G09F 15/025; B65D 59/04; G09F 15/0062

(57) ABSTRACT

A television template kit with different sized sheets includes a plurality of television sized sheets and at least one highly contrastable graphic. Each of the plurality of television sized sheets includes a front surface, a rear surface, and a diagonal sizing indicator. The front surface and the rear surface are oppositely positioned of each other about each of the plurality of television sized sheets. The highly contrastable graphic is perimetrically inscribe onto the front surface of each of the plurality of television sized sheets. The diagonal sizing indicator that demonstrates the actual television size is inscribed onto the highly contrastable graphic of each of the plurality of television sized sheets. Furthermore, a height indicator and a width indicator are inscribed onto the highly contrastable graphic of each of the plurality of television sized sheets.

The current application claims a priority to the U.S. Provisional Patent application Ser. No. 62/649,739 filed on Mar. 29, 2018.

### FIELD OF THE INVENTION

The present invention generally relates to television templates. More specifically, television templates serve as physical representations of different sized actual televisions on the wall, or other places designed by the user, before the user purchases the actual television.

### BACKGROUND OF THE INVENTION

Television has been an important home electronic device since the twentieth century. Many people even have multiple televisions at home: one in the living room, one in the bedroom, or even one in the kid's bedroom. Many users turn on a television multiple times in a day, for news, weather, movie, entertainment, or simply to have some noise in the room. However, as technology improves, there are different types and sizes of televisions for the user to choose from, and issues arise when the user is trying to decide on what size of television the user should buy and where to place the television. For example, when a user wants to purchase a fifty-inch television but needs some references to decide the general height and location of the television in a room, the user may want to see a physical representation of the fifty-inch television on the wall before buying the television. In other words, it is beneficial for the user to have a physical reference of the television on the wall or other surfaces to get a better idea of the actual viewing the television before performing the purchase.

The present invention solves the above issues by providing a number of television sized sheets that can provide a physical representation of actual television sizes. By attaching the present invention to the wall or other surfaces designated by the user, the user can get a good glimpse of how a television can be arranged in the room. For example, by putting different sizes of templates on the wall, the user may have a better idea about how to arrange other pieces of furniture around the room or the size of the television appropriate for the room. Moreover, by having a physical representation as a reference, the user can consider how different television sizes can affect the arrangement of a room. For example, the user may also need to adjust the lighting or window curtains to fit the new television, or the user can move other pieces of furniture to different locations to create enough room for both the television and the viewers.

### SUMMARY OF THE INVENTION

The present invention is a television template kit with different sized sheets for the user to simulate the actual television size before the user purchases the actual television. The user may purchase and use the template as a physical representation on the wall or other designated surfaces to get a better idea of which size of television to buy, and how to arrange the room accordingly. The present invention preferably provides a kit provided within a container. The present invention preferably provides six templates of different sizes representing different television sizes.

### BRIEF DESCRIPTION OF THE DRAWINGS

FIG. 1 is a perspective front view of the plurality of television sized sheets of the present invention, without showing the diagonal sizing indicator.

FIG. 2 is a perspective rear view of the plurality of television sized sheets of the present invention.

FIG. 3 is a front view for the first sheet of the plurality of television sized sheets of the present invention, wherein the diagonal sizing indicator is the 40 inch indicator.

FIG. 4 is a front view for the second sheet of the plurality of television sized sheets of the present invention, wherein the diagonal sizing indicator is the 49 inch indicator.

FIG. 5 is a front view for the third sheet of the plurality of television sized sheets of the present invention, wherein the diagonal sizing indicator is the 55 inch indicator.

FIG. 6 is a front view for the fourth sheet of the plurality of television sized sheets of the present invention, wherein the diagonal sizing indicator is the 65 inch indicator.

FIG. 7 is a front view for the fifth sheet of the plurality of television sized sheets of the present invention, wherein the diagonal sizing indicator is the 75 inch indicator.

FIG. 8 is a front view for the sixth sheet of the plurality of television sized sheets of the present invention, wherein the diagonal sizing indicator is the 85 inch indicator.

FIG. 9 is a perspective exploded view of the tubular container of the present invention.

FIG. 10 is a front view of the sixth sheet of the plurality of television sized sheets and the front view of the tubular container, wherein the length of the cylindrical body is larger than the width indicator of the sixth sheet.

### DETAIL DESCRIPTIONS OF THE INVENTION

All illustrations of the drawings are for the purpose of describing selected versions of the present invention and are not intended to limit the scope of the present invention.

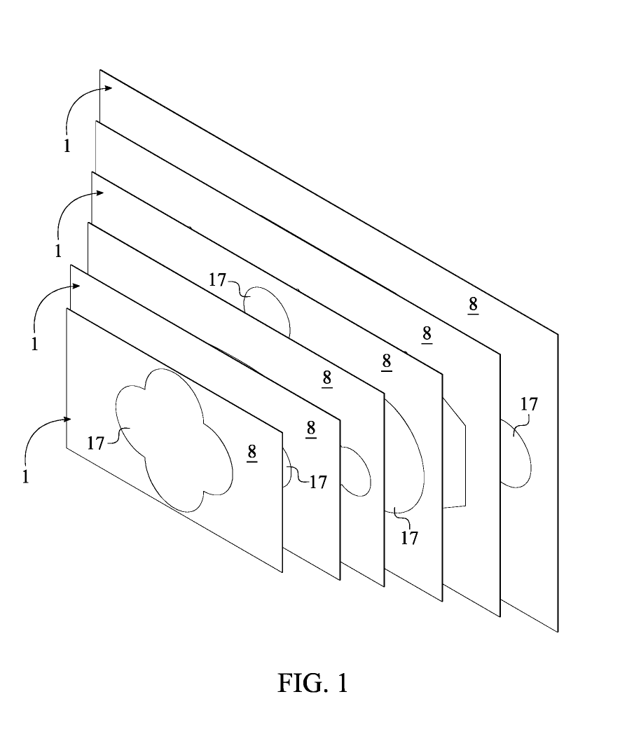

The present invention is a television template kit with different sized sheets. The different sized sheets are configured to provide a good estimate to the user regarding the size of a television relative to the dimensions and the layout of the room. The different sized sheets are generally square shaped and comes in various sizes to simulate different sizes of televisions. In order to accomplish the abovementioned task, the present invention comprises a plurality of television sized sheets 1 and at least one highly contrastable graphic 17 as shown in FIG. 1. Each of the plurality of television sized sheets 1 represents various television sizes as the plurality of television sized sheets 1 each comprises a front surface 8, a rear surface 9, and a diagonal sizing indicator 10. The plurality of television sized sheets 1 is preferably made of paper to maintain a lower production cost; however, the plurality of television sized sheets 1 is not limited to paper can be made of any other types of material such as composite, plastic, fabric, and metal.

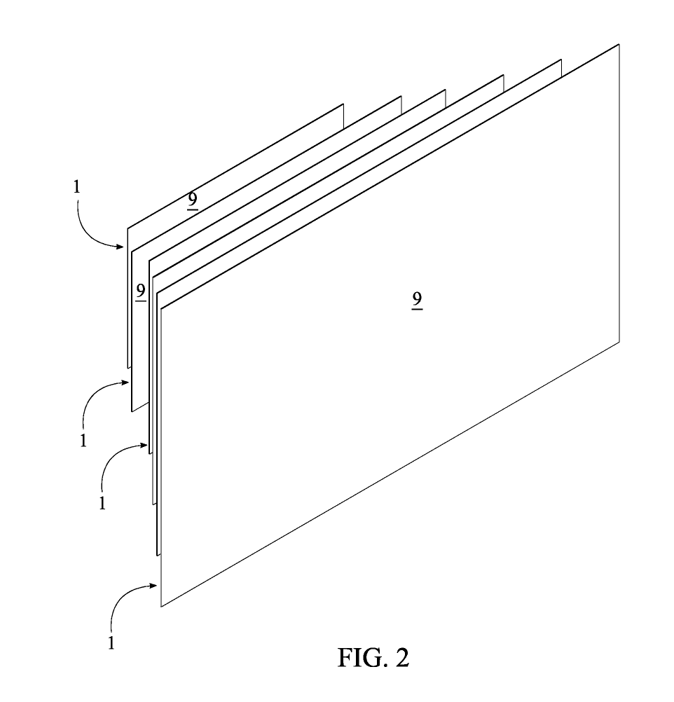

In reference to FIG. 1-2, the front surface 8 and the rear surface 9 are oppositely positioned of each other about each of the plurality of television sized sheets 1 thus delineating a front view and a rear view for each television sized sheet. The rear surface 9 provides sufficient surface area to attach each of the plurality of television sized sheets 1 to a wall or any other hanging surface that the actual television may be mounted through an attaching mechanism. More specifically, the attaching mechanism is configured to attach the each of the plurality of television sized sheets 1 to the wall or any other hanging surface as the attaching mechanism can include, but is not limited to, tape, temporary glue, push pins, and hook-and-loop fasteners. The front surface 8 provides sufficient surface area to inscribe any dimensional specifications for informational purpose and to inscribe the highly contrastable graphic 17 that separates the parameters of the each of the plurality of television sized sheets 1 form the wall or any other hanging surface. More specifically, the highly contrastable graphic 17 is perimetrically inscribe onto the front surface 8 of each of the plurality of television sized sheets 1 so that each of the plurality of television sized sheets 1 can be visually separated from the wall or any other hanging surface clearly indicating the parameters of the actual television. The highly contrastable graphic 17 is individually different within each of the plurality of television sized sheets 1 to clearly differentiate each of the plurality of television sized sheets 1 from each other. The diagonal sizing indicator 10 is inscribed onto the highly contrastable graphic 17 of each of the plurality of television sized sheets 1 so that the user can visually identify the correct size of the television.

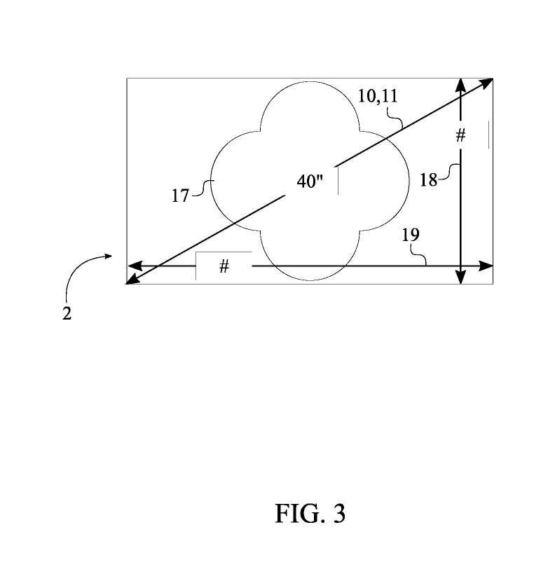

In reference to FIG. 3-8, the present invention further comprises a height indicator 18 that visually illustrates a vertical dimension for each of the plurality of television sized sheets 1. More specifically, the height indicator 18 provides an additional dimensional reference for the user so that the user is able to optimize the vertical placement of the actual television with respect to the existing obstruction such as hanging light fixtures. Furthermore, the height indicator 18 also enables the user to design placement of the vertical accessories with respect to the actual television and the height of wall or any other hanging surface. For example, the height indicator 18 aids the user to determine the vertical placement of a floating self or the proper height of a television stand.

In reference to FIG. 3-8, the present invention further comprises a width indicator 19 that visually illustrates a horizontal dimension for each of the plurality of television sized sheets 1. More specifically, the width indicator 19 provides an additional dimensional reference for the user so that the user is able to optimize the horizontal placement of the actual television with respect to the existing obstruction such as doors and windows. Furthermore, the width indicator 19 also enables the user to design placement of the horizontal accessories with respect to the actual television and the width of wall or any other hanging surface. For example, the width indicator 19 aids the user to determine the symmetrical placement for a pair of front speakers with respect to the width of wall or any other hanging surface.

In the preferred embodiment of the present invention, the plurality of television sized sheets 1 is six television sized sheets 1. However, the present invention is not limited to six television sized sheets 1 and can be any other number of television sized sheets 1 as it can be seen as an obvious difference.

In reference to FIG. 3, the plurality of television sized sheets 1 comprises a first sheet 2, wherein the diagonal sizing indicator 10 is a 40 inch indicator 11. More specifically, the 40 inch indicator 11 is inscribed onto the highly contrastable graphic 17 of the first sheet 2. Furthermore, the 40 inch indicator 11 extends from a top corner of the first sheet 2 to a bottom-opposite corner of the first sheet 2 thus delineating the diagonal measurement of the first sheet 2. The height indicator 18 and the width indicator 19 are also inscribed onto the highly contrastable graphic 17 of the first sheet 2 in order to display the corresponding vertical dimension and the horizontal dimension.

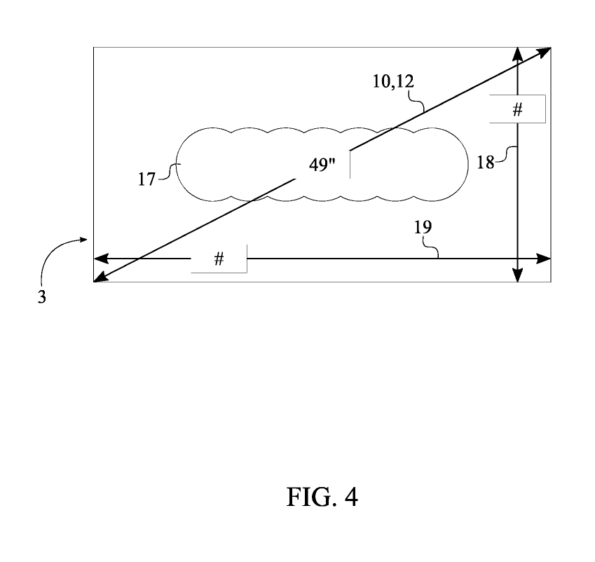

In reference to FIG. 4, the plurality of television sized sheets 1 comprises a second sheet 3, wherein the diagonal sizing indicator 10 is a 49 inch indicator 12. More specifically, the 49 inch indicator 12 is inscribed onto the highly contrastable graphic 17 of the second sheet 3. Furthermore, the 49 inch indicator 12 extends from a top corner of the second sheet 3 to a bottom-opposite corner of the second sheet 3 thus delineating the diagonal measurement of the second sheet 3. The height indicator 18 and the width indicator 19 are also inscribed onto the highly contrastable graphic 17 of the second sheet 3 in order to display the corresponding vertical dimension and the horizontal dimension.

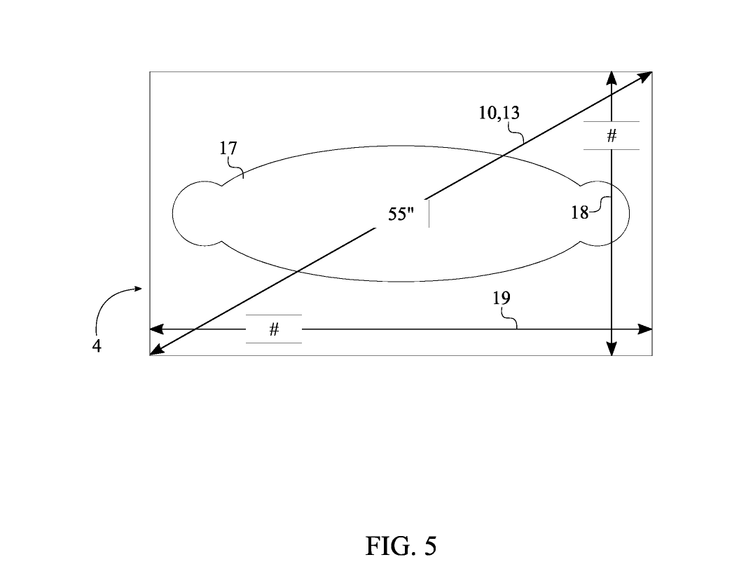

In reference to FIG. 5 the plurality of television sized sheets 1 comprises a third sheet 4, wherein the diagonal sizing indicator 10 is a 55 inch indicator 13. More specifically, the 55 inch indicator 13 is inscribed onto the highly contrastable graphic 17 of the third sheet 4. Furthermore, the 55 inch indicator 13 extends from a top corner of the third sheet 4 to a bottom-opposite corner of the third sheet 4 thus delineating the diagonal measurement of the third sheet 4. The height indicator 18 and the width indicator 19 are also inscribed onto the highly contrastable graphic 17 of the third sheet 4 in order to display the corresponding vertical dimension and the horizontal dimension.

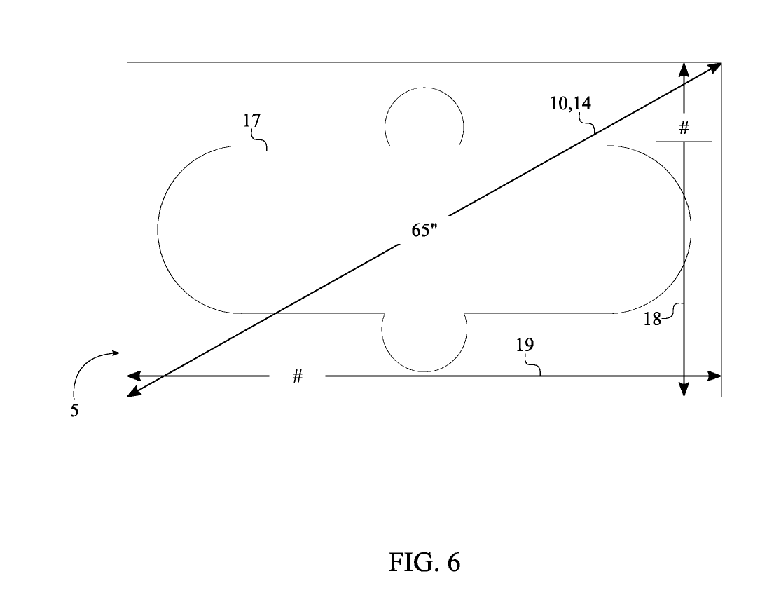

In reference to FIG. 6 the plurality of television sized sheets 1 comprises a fourth sheet 5, wherein the diagonal sizing indicator 10 is a 65 inch indicator 14. More specifically, the 65 inch indicator 14 is inscribed onto the highly contrastable graphic 17 of the fourth sheet 5. Furthermore, the 65 inch indicator 14 extends from a top corner of the fourth sheet 5 to a bottom-opposite corner of the fourth sheet 5 thus delineating the diagonal measurement of the fourth sheet 5. The height indicator 18 and the width indicator 19 are also inscribed onto the highly contrastable graphic 17 of the fourth sheet 5 in order to display the corresponding vertical dimension and the horizontal dimension.

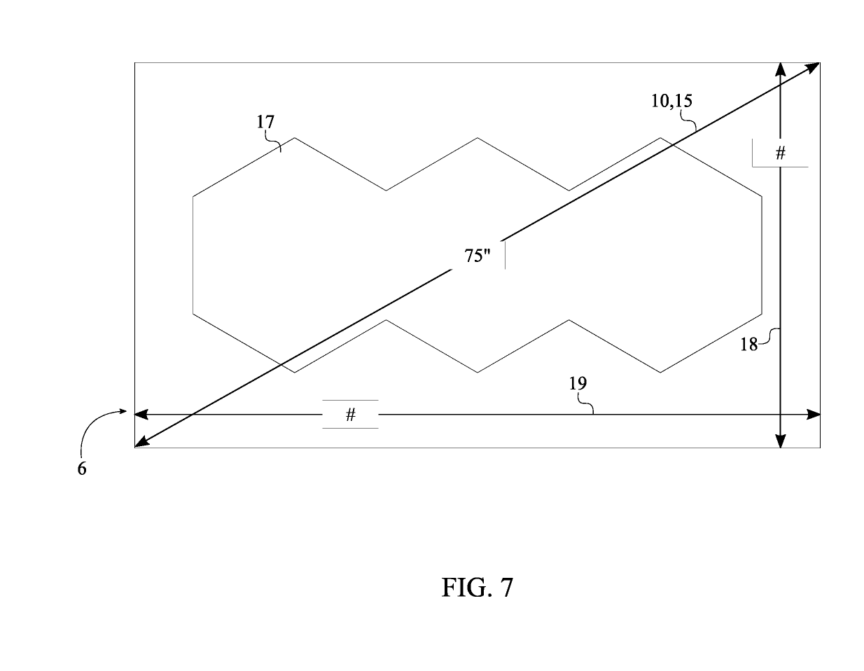

In reference to FIG. 7, the plurality of television sized sheets 1 comprises a fifth sheet 6, wherein the diagonal sizing indicator 10 is a 75 inch indicator 15. More specifically, the 75 inch indicator 15 is inscribed onto the highly contrastable graphic 17 of the fifth sheet 6. Furthermore, the 75 inch indicator 15 extends from a top corner of the fifth sheet 6 to a bottom-opposite corner of the fifth sheet 6 thus delineating the diagonal measurement of the fifth sheet 6. The height indicator 18 and the width indicator 19 are also inscribed onto the highly contrastable graphic 17 of the fifth sheet 6 in order to display the corresponding vertical dimension and the horizontal dimension.

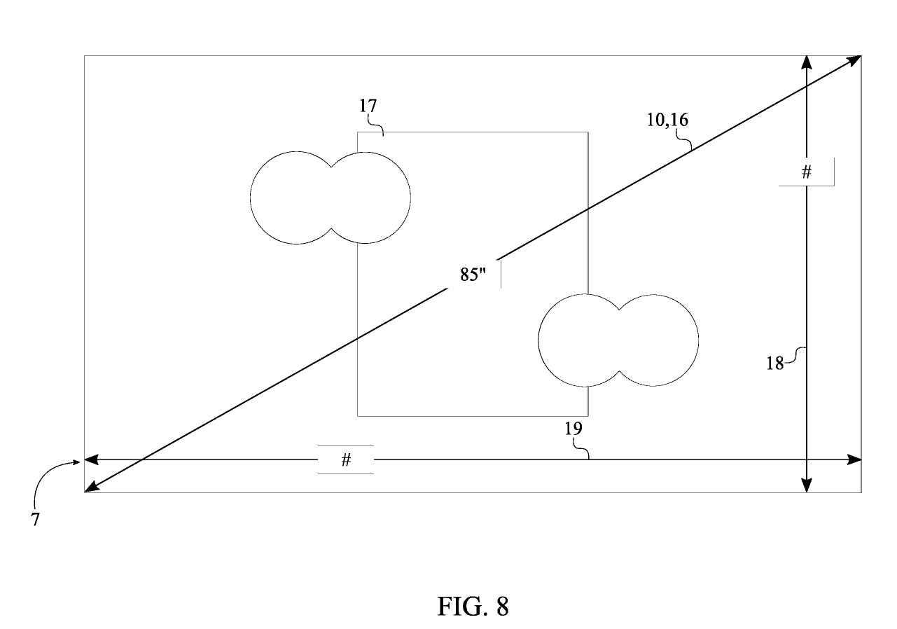

In reference to FIG. 8, the plurality of television sized sheets 1 comprises a sixth sheet 7, wherein the diagonal sizing indicator 10 is an 85 inch indicator 16. More specifically, the 85 inch indicator 16 is inscribed onto the highly contrastable graphic 17 of the sixth sheet 7. Furthermore, the 85 inch indicator 16 extends from a top corner of the sixth sheet 7 to a bottom-opposite corner of the sixth sheet 7 thus delineating the diagonal measurement of the sixth sheet 7. The height indicator 18 and the width indicator 19 are also inscribed onto the highly contrastable graphic 17 of the sixth sheet 7 in order to display the corresponding vertical dimension and the horizontal dimension.

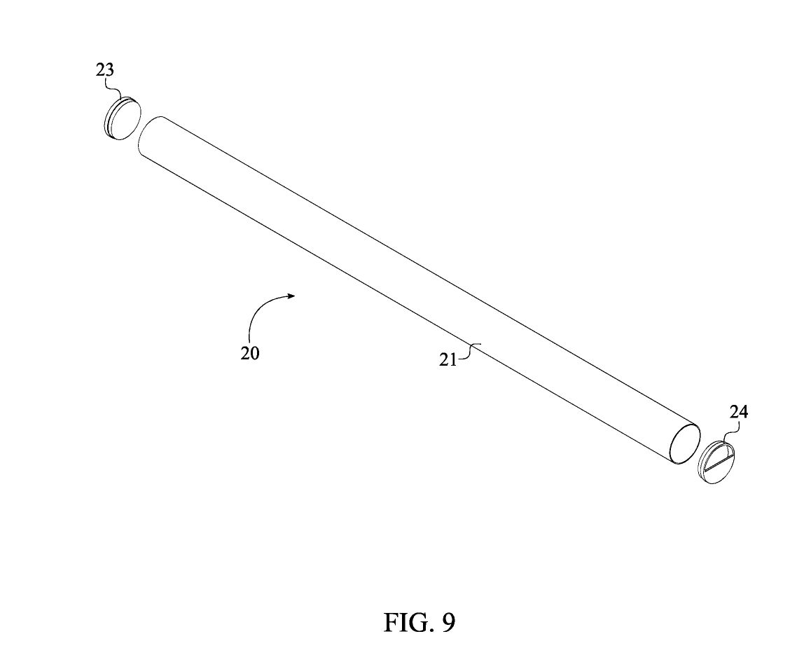

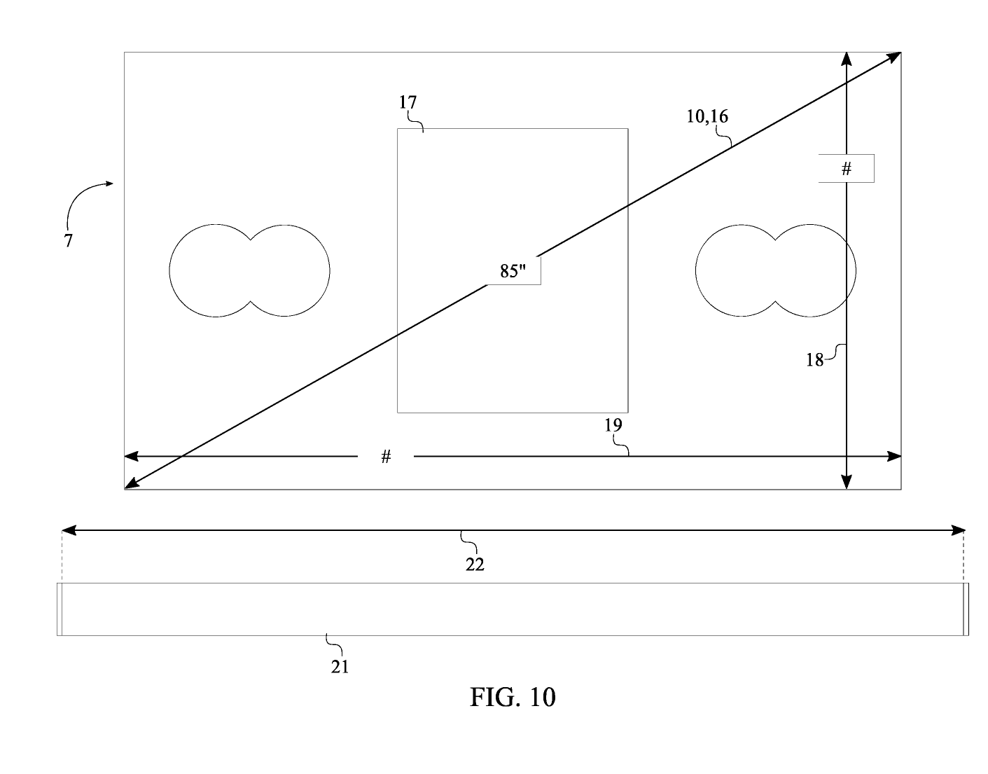

In reference to FIG. 9-10, the present invention further comprises a tubular container 20 as the plurality of television sized sheets 1 is enclosed within the tubular container 20 for storage purpose. The tubular container 20 comprises a cylindrical body 21, a first end-cap 23, and a second end-cap 24. The first end-cap 23 is terminally attached to the cylindrical body 21. The second end-cap 24 is terminally attached to the cylindrical body 21 and positioned opposite of the first end-cap 23. Resultantly, the plurality of television sized sheets 1 is able to enclose within the cylindrical body 21, the first end-cap 23, and the second end-cap 24 as the removal of the first end-cap 23 or the second end-cap 24 allows the plurality of television sized sheets 1 to be inserted or removed. Furthermore, a length 22 of the cylindrical body 21 is larger than a width indicator 19 of the sixth sheet 7 that is the largest plurality of television sized sheets 1. Optionally, the actual television sizes that relates to the diagonal sizing indicator 10 of each of plurality of television sized sheets 1 are preferably inscribed on an outer surface of the tubular container 20 for the user to consider, as well as any other plurality of indicia which may represent the brand, other graphics, and/or advertisements.

The present invention can be purchased and delivered to the user. The user may take out the plurality of television sized sheets 1 from the tubular container 20, unroll the plurality of television sized sheets 1 and attach a desired sheet from the plurality of television sized sheets 1 to the wall or any other hanging surface by the attachment mechanism, then use the desired sheet as the physical reference of a television to arrange other furniture or lighting accordingly. If the user prefers other television sizes, the user can detach the desired sheet, then attach a different sheet from the plurality of television sized sheets 1 to the designated location until the correct size of the actual television is determined. The user can also incrementally place more than one sheet in the same location to determine the most appropriate television size which should be placed. Alternatively, the user may place several sheets of similar size in different positions to determine the most appropriate location to place the television.

Although the invention has been explained in relation to its preferred embodiment, it is to be understood that many other possible modifications and variations can be made without departing from the spirit and scope of the invention as hereinafter claimed.

What is claimed is:

1. A television template kit with different sized sheets comprises:
a plurality of television sized sheets;
at least one highly contrastable graphic;
each of the plurality of television sized sheets comprises a front surface, a rear surface, and a diagonal sizing indicator;
the front surface and the rear surface being oppositely positioned of each other about each of the plurality of television sized sheets;
the highly contrastable graphic being perimetrically inscribe onto the front surface of each of the plurality of television sized sheets; and
the diagonal sizing indicator being inscribed onto the highly contrastable graphic of each of the plurality of television sized sheets.

2. The television template kit with different sized sheets as claimed in claim 1 comprises:
a height indicator; and
the height indicator being inscribed onto the highly contrastable graphic of each of the plurality of television sized sheets.

3. The television template kit with different sized sheets as claimed in claim 1 comprises:
a width indicator; and
the width indicator being inscribed onto the highly contrastable graphic of each of the plurality of television sized sheets.

4. The television template kit with different sized sheets as claimed in claim 1 comprises;
the plurality of television sized sheets comprises a first sheet;
the diagonal sizing indicator being a 40 inch indicator; and
the 40 inch indicator being inscribed onto the highly contrastable graphic of the first sheet.

5. The television template kit with different sized sheets as claimed in claim 1 comprises;
the plurality of television sized sheets comprises a second sheet;
the diagonal sizing indicator being a 49 inch indicator; and
the 49 inch indicator being inscribed onto the highly contrastable graphic of the second sheet.

6. The television template kit with different sized sheets as claimed in claim 1 comprises;
the plurality of television sized sheets comprises a third sheet;
the diagonal sizing indicator being a 55 inch indicator; and
the 55 inch indicator being inscribed onto the highly contrastable graphic of the third sheet.

7. The television template kit with different sized sheets as claimed in claim 1 comprises;
the plurality of television sized sheets comprises a fourth sheet;
the diagonal sizing indicator being a 65 inch indicator; and
the 65 inch indicator being inscribed onto the highly contrastable graphic of the fourth sheet.

8. The television template kit with different sized sheets as claimed in claim 1 comprises;
the plurality of television sized sheets comprises a fifth sheet;
the diagonal sizing indicator being a 75 inch indicator; and
the 75 inch indicator being inscribed onto the highly contrastable graphic of the fifth sheet.

9. The television template kit with different sized sheets as claimed in claim 1 comprises;
the plurality of television sized sheets comprises a sixth sheet;
the diagonal sizing indicator being an 85 inch indicator; and
the 85 inch indicator being inscribed onto the highly contrastable graphic of the sixth sheet.

10. The television template kit with different sized sheets as claimed in claim 1 comprises:
a tubular container; and
the plurality of television sized sheets being enclosed within the tubular container.

11. The television template kit with different sized sheets as claimed in claim 10 comprises:
the tubular container comprises a cylindrical body, a first end-cap, and a second end-cap;
the first end-cap being terminally attached to the cylindrical body;
the second end-cap being terminally attached to the cylindrical body, opposite of the first end-cap; and
the plurality of television sized sheets being enclosed within the cylindrical body, the first end-cap, and the second end-cap.

12. The television template kit with different sized sheets as claimed in claim 10 comprises:
the tubular container comprises a cylindrical body;
the plurality of television sized sheets comprises a sixth sheet; and
a length of the cylindrical body being larger than a width indicator of the sixth sheet.

13. A television template kit with different sized sheets comprises:
a plurality of television sized sheets;
at least one highly contrastable graphic;
a height indicator;
a width indicator;
each of the plurality of television sized sheets comprises a front surface, a rear surface, and a diagonal sizing indicator;
the front surface and the rear surface being oppositely positioned of each other about each of the plurality of television sized sheets;
the highly contrastable graphic being perimetrically inscribe onto the front surface of each of the plurality of television sized sheets;
the height indicator being inscribed onto the highly contrastable graphic of each of the plurality of television sized sheets;
the width indicator being inscribed onto the highly contrastable graphic of each of the plurality of television sized sheets; and
the diagonal sizing indicator being inscribed onto the highly contrastable graphic of each of the plurality of television sized sheets.

14. The television template kit with different sized sheets as claimed in claim 13 comprises;
the plurality of television sized sheets comprises a first sheet;
the diagonal sizing indicator being a 40 inch indicator; and
the 40 inch indicator being inscribed onto the highly contrastable graphic of the first sheet.

15. The television template kit with different sized sheets as claimed in claim 13 comprises;
the plurality of television sized sheets comprises a second sheet;
the diagonal sizing indicator being a 49 inch indicator; and
the 49 inch indicator being inscribed onto the highly contrastable graphic of the second sheet.

16. The television template kit with different sized sheets as claimed in claim 13 comprises;
the plurality of television sized sheets comprises a third sheet;
the diagonal sizing indicator being a 55 inch indicator; and
the 55 inch indicator being inscribed onto the highly contrastable graphic of the third sheet.

17. The television template kit with different sized sheets as claimed in claim 13 comprises;
the plurality of television sized sheets comprises a fourth sheet;
the diagonal sizing indicator being a 65 inch indicator; and
the 65 inch indicator being inscribed onto the highly contrastable graphic of the fourth sheet.

18. The television template kit with different sized sheets as claimed in claim 13 comprises;
the plurality of television sized sheets comprises a fifth sheet;
the diagonal sizing indicator being a 75 inch indicator; and
the 75 inch indicator being inscribed onto the highly contrastable graphic of the fifth sheet.

19. The television template kit with different sized sheets as claimed in claim 13 comprises;
the plurality of television sized sheets comprises a sixth sheet;
the diagonal sizing indicator being an 85 inch indicator; and
the 85 inch indicator being inscribed onto the highly contrastable graphic of the sixth sheet.

20. The television template kit with different sized sheets as claimed in claim 13 comprises:
a tubular container;
the plurality of television sized sheets comprises a sixth sheet;
the tubular container comprises a cylindrical body, a first end-cap, and a second end-cap;
the first end-cap being terminally attached to the cylindrical body;
the second end-cap being terminally attached to the cylindrical body, opposite of the first end-cap;
the plurality of television sized sheets being enclosed within the tubular container;
the plurality of television sized sheets being enclosed within the cylindrical body, the first end-cap, and the second end-cap; and
a length of the cylindrical body being larger than a width indicator of the sixth sheet.
